(19) United States
(12) Patent Application Publication
(10) Pub. No.: US 2008/0270279 A1
(43) Pub. Date: Oct. 30, 2008

(54) Method and system for automated skip tracing

(76) Inventors: Paul J. Rowe, Columbus, GA (US); Tim Edgar, Pine Mountain, GA (US); Rene Andringa, Fortson, GA (US)

Correspondence Address: KING & SPALDING LLP, 1180 PEACHTREE STREET, ATLANTA, GA, 30309-3521, US

(21) Appl. No.: 12/150,155

(22) Filed: Apr. 25, 2008

Related U.S. Application Data
(60) Provisional application No. 60/926,492, filed on Apr. 27, 2007.

(51) Int. Cl. G06Q 30/00

(52) U.S. Cl. 705/35

(57) ABSTRACT

Automating a skip trace process for identifying contact information for account holders of financial accounts that cannot otherwise be reached. The systems and methods may include the ability to submit skip trace inquiries through a variety of platforms, including electronic mail, formatted file, or directly from a financial account processing system. The systems and methods interact with third party data sources, data aggregators, or data processors to identify potential contact information for the individual. The systems and methods incorporate automated contact campaigns to verify any possible contact information retrieved.

### STATEMENT OF RELATED PATENT APPLICATIONS

This non-provisional patent application claims priority under 35 U.S.C. §119 to U.S. Provisional Patent Application No. 60/926,492, titled Method and System for Automated Skip Tracing, filed Apr. 27, 2007. This provisional application is hereby fully incorporated herein by reference.

### FIELD OF THE INVENTION

This invention relates to systems and methods that provide automated skip tracing. More particularly, this invention relates to processes and systems that allow financial institutions or financial transaction processors to locate customers that have changed contact information or otherwise cannot be initially located.

### BACKGROUND OF THE INVENTION

The use of financial cards for conducting financial transactions is ubiquitous. Typically, a credit card represents a line of credit that has been issued from a financial institution, the account provider, to an individual, the account holder. The credit card allows the account holder to purchase goods and services against the line of credit. The line of credit is associated with an account and that account has certain terms governing how credit is extended to the account holder. Typical terms include an annual interest rate charged on the amount of money actually lent to the account holder, a grace period that allows the account holder to pay for purchases without incurring interest charges, annual fees for the account, and other fees, such a late payment fees. Credit cards may be issued by national card associations, such as AMERICAN EXPRESS or DISCOVER CARD; a financial institution in conjunction with a national card association, such as a Bank of America VISA or MASTERCARD; or directly from a retailer, such as MACY'S or BRITISH PETROLEUM.

Credit card and other financial card purchase transactions follow the same general process. An account holder makes a purchase from a merchant and presents a card to pay for the purchase. The information from the card is taken by the merchant and sent, along with information about the purchase and merchant, to a transaction processor. This transaction processor may be a card association, like American Express, or a third-party vendor, who provides a service to financial institutions by authorizing financial card transactions. If approved, the transaction appears on the account holder's bill in the next billing cycle, which typically runs on a monthly basis. To ensure that the account is maintained in an active status and to avoid certain penalties, the account holder would typically pay anywhere between a minimum required payment up to the total balance on the account.

This normal transaction process breaks down if the account holder cannot be located, either by telephone because they have changed their phone number or through conventional or electronic mail. For example, the account holder may move and not notify the account provider of a new address or not provide a forwarding address to the post office. In another example, billing communication may be by way of electronic notification and the account holder may change her electronic mail account. This failure to provide current address information to an account provider may be inadvertent or intentional. The account holder may then use the financial card to make a purchase, yet fails to make a payment because a bill did not reach the account holder. In this case, the account provider attempts to locate the account holder to secure payment on the account. This effort to locate the account holder is called a “skip trace.”

Although skip tracing may commonly occur for credit card or other financial accounts, the process has other applications. For example, government agencies may employ the process to find individuals that owe taxes, motor vehicle violation fines, or otherwise owe money to the governmental entity.

The typical process for a skip trace involves a person-intensive process. Often, the costs for this process outweigh the return to the account provider. As such, the account provider may have to take a loss on the unpaid bill. What is needed are systems and methods that automate the skip-trace process, thus reducing the process's cost. This method would use computers and automated communications devices to search for and attempt to contact an individual that is the target of a skip trace.

### SUMMARY OF THE INVENTION

The present invention supports systems and methods that automate a skip trace process for identifying contact information for account holders of financial accounts or individuals with other financial obligations that cannot otherwise be reached. The systems and methods may include the ability to submit skip trace inquiries through a variety of platforms, including electronic mail, formatted file, or directly from a financial account processing system. The systems and methods interact with third party data sources, data aggregators, or data processors to identify potential contact information for the individual. The systems and methods incorporate automated contact campaigns to verify any possible contact information retrieved. One aspect of the present invention provides a system for automated skip tracing. The system includes a data receipt module, operable to receive a skip trace inquiry that includes information on a financial account; a policy module, operable to apply one or more policies to the skip trace inquiry received by the data receipt module to identify one or more skip trace inquiries for processing; a skip trace processing module; operable to process the skip trace inquiries identified by the policy module by requesting and receiving contact information associated with the processed skip trace inquiries; and an automated dialing module; operable to automatically initiate communications using the received contact information.

Another aspect of the present invention provides a system for automated skip tracing. This system includes one or more servers, logically connected to a network and operable to receive a skip trace inquiry that includes information a financial account, to apply one or more policies to the skip trace inquiry received by the server to identify one or more financial accounts for skip trace processing, and to process the skip trace inquiries identified by the policy module by requesting and receiving contact information associated with the processed skip trace inquiries; and an automated dialer; operable to automatically initiate communications using the received contact information.

Yet another aspect of the present invention provides a method for automating skip tracing. This method includes the steps of: a) receiving a skip trace inquiry that includes information a financial account; b) applying one or more policies to determine if the skip trace inquiry should be processed; c) processing the skip trace inquiry to identify contact information for an individual associated with the skip trace inquiry; and d) automatically initiating contact with the individual associated with the skip trace inquiry using the contact information.

### BRIEF DESCRIPTION OF THE DRAWINGS

FIG. 1 depicts an operating environment in accordance with an exemplary embodiment of the present invention.

FIG. 2 depicts a system architecture in accordance with an exemplary embodiment of the present invention.

FIG. 3 depicts an overall process flow diagram for providing an automated skip trace in accordance with an exemplary embodiment of the present invention.

FIG. 4 depicts a detailed process flow diagram for providing an automated skip trace in accordance with an exemplary embodiment of the present invention.

FIG. 5 depicts a detailed process flow diagram for further processing an automated skip trace case in accordance with an exemplary embodiment of the present invention.

### DETAILED DESCRIPTION OF THE EXEMPLARY EMBODIMENTS

Exemplary embodiments of the present invention are provided. These embodiments include systems and methods that automate a skip trace process for identifying contact information for account holders of financial accounts or individuals with other financial obligations that cannot otherwise be reached. The systems and methods may include the ability to submit skip trace inquiries through a variety of platforms, including electronic mail, formatted file, or directly from a financial account processing system. The systems and methods interact with third party data sources, data aggregators, or data processors to identify potential contact information for the individual. The systems and methods incorporate automated contact campaigns to verify any possible contact information retrieved.

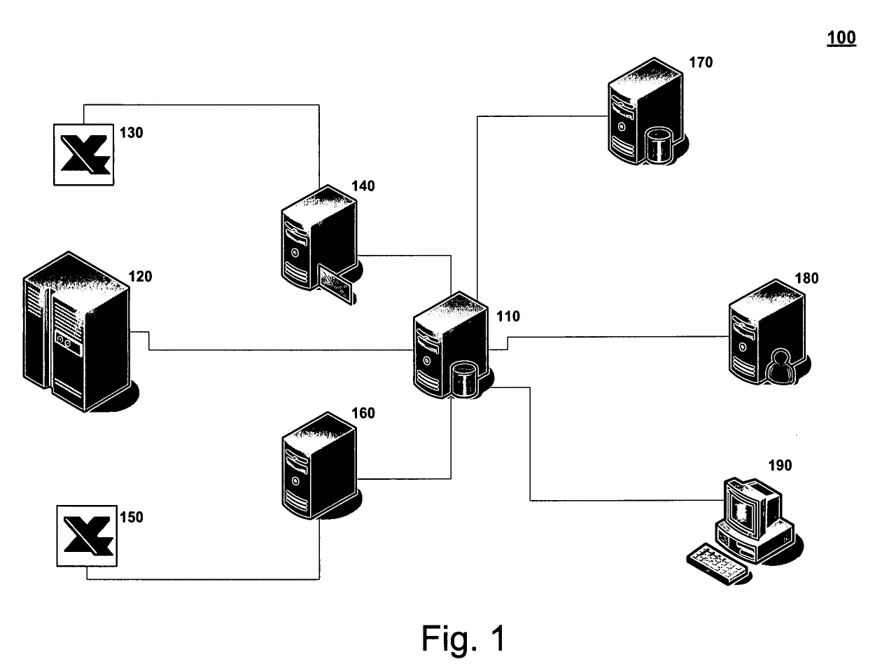

FIG. 1 depicts an operating environment 100 in accordance with an exemplary embodiment of the present invention. Referring to FIG. 1, the environment 100 includes a skip trace database server 110. The skip trace database server 110 may be part of a local area network (LAN), wide area network, including the Internet, or a part of both types of networks. The skip trace database server 110 may be connected to one or more computer (not shown) that control the programming and operation of the skip trace database server 110. In this exemplary embodiment, the skip trace database server 110 receives and processes skip trace cases. Each skip trace case represents a financial account where the associated account holder cannot be located.

For some cases, the skip trace database server 110 communicates with an account processing platform 120. The account processing platform 120 may process financial accounts, such as for financial card accounts. This account processing platform 120 may support signing up for an account and processing transactions for the account. This account processing platform 120 may include a process that identifies delinquent accounts, that is, accounts for which payment is past the established due date. For delinquent accounts, the account processing platform 120 would transmit a file to a skip trace queue on the skip trace database server 110, which then acts on the file. This file may provide account information for the delinquent account to support a skip trace process. In one embodiment, financial accounts may be designated for transfer to the skip trace queue from the account processing platform 120 by an account representative, or agent. For example, the account agent may try to reach the individual named on a delinquent account at the contact information associated with the account. The agent may be unable to reach the individual at the contact location. The agent would then indicate that the account should be processed in the skip trace process. In alternative embodiments, a delinquent account may be designated for skip trace processing because an electronic mail message was returned as undeliverable or based on some other indication that the account holder cannot be reached.

The skip trace database server 110 may also receive financial accounts in the skip trace queue from other sources. For one set of cases, a financial account processor or financial account provider may send account information 130 by way of electronic mail to an electronic mail server 140. In this exemplary embodiment, the account information 130 is contained in a structured data file, such as a file with comma separated values (CSV). These files may be encrypted so that sensitive account information is not stolen as the electronic mail is transferred to the electronic mail server 140 from the sending computer (not shown).

For another set of cases, a financial account processor or financial account provider may send account information 150 by way of a secure connection to an file transfer server 160. In this exemplary embodiment, the account information 150 is contained in a structured data file, such as a CSV file. A 128-bit secured connection serves to protect any sensitive customer information from being stolen as the file is uploaded from the sending computer (not shown) to the file transfer server 160. The file transfer server 160 may be a web server and the files uploaded over an Internet connection.

In this exemplary embodiment, the skip trace database server 110 is also connected to a one or more third party skip trace database servers, such as third party skip trace database server 170. The third party skip trace database server 170 contains data records that contain contact information on individuals, for example one or more phone numbers or addresses for the individual. In one embodiment, the addresses may include electronic mail addresses. Alternatively or additionally, the third party skip trace database server 170 may contact other data sources (not shown) that contain contact information for individuals. The skip trace database server 110 is electronically connected to the third party skip trace database server 170, such as through a dedicated line or a wide area network, such as the Internet. The third party skip trace database server 170 contains (or can retrieve) the raw data that yields the contact information used in the skip trace process.

The skip trace database server 110 receives contact information back from the third party skip trace databases, such as third party skip trace database server 170. The skip trace database server 110 then interacts with a computer-controlled automatic dialer 180. The computer-controlled automatic dialer 180 receives computer files from the skip trace database server 110 that contains telephone contact information. The computer files may be encrypted to protect any customer sensitive information. In an alternative embodiment, this “dialer” may send electronic mail messages. The computer-controlled automatic dialer 180 is operable to automatically call phone numbers as identified in the computer file.

A computer 190 can be used by an agent to verify any numbers identified by the computer-controlled automatic dialer 180. The computer-controlled automatic dialer 180 would route a call to the agent at computer 190 so that the agent can directly confirm that the individual that is the subject of the skip trace has been located.

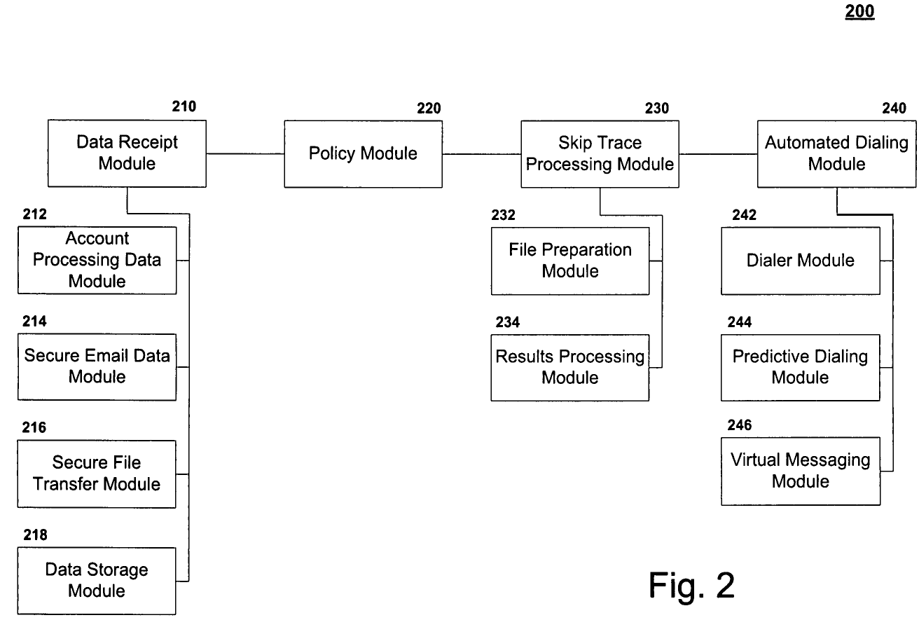

FIG. 2 depicts a system architecture 200 in accordance with an exemplary embodiment of the present invention. Referring to FIGS. 1 and 2, a data receipt module 210 receives and processes computer files representing skip trace cases from a skip trace queue. The data receipt module 210 may include a number of sub modules. An account processing data module 212 receives and processes skip trace files from an account processing platform, such as account processing platform 120. A secure email data module 214 receives and processes skip trace files transmitted to an electronic mail server, such as electronic mail server 140. A secure file transfer module 216 receives and processes skip trace files transmitted to a file transfer server, such as file transfer server 160. A data storage module 218 stores processed skip trace case files. The data storage module 218 takes the processed information and stores data necessary for the skip trace process in a database, such as a database resident on the skip trace database server 110.

A policy module 220 is operable to evaluate each skip trace case. This evaluation determines if the case is “compliant,” “non-compliant,” or “redundant.” A compliant case conforms with any policies that concern the case. A non-compliant case fails to conform with one or more policies that concern the case. Finally, a redundant case represents a case that is currently being processed but that is contained in a different skip trace case file. Policies may include business rules used to determine if a case should be skip trace processed.

A skip trace processing module 230 processes each skip trace case file that was determined to be compliant by the policy module 220. The skip trace processing module 230 may include a file preparation module 232, operable to format and secure necessary information to support the identification of potential contact information for the subject of the skip trace, such as by the third party skip trace database server 170. The skip trace processing module 230 may also include a results processing module 234, operable to receive data consisting of potential contact information for the subject of the skip trace, such as from the third party skip trace database server 170. For example, the results processing module 234 may format the contact information received by the third party skip trace database server 170 to encrypt the data and place the data in a form that can be used by an automated dialer, such as automatic dialer 180.

An automated dialing module 240 controls an automated dialing campaign, such as a campaign by automatic dialer 180. The automated dialing module 240 may include a dialer module 242, operable to automatically place telephone calls to indicated telephone numbers. In an alternative embodiment, the dialer module 242 may automatically send out electronic mail messages.

The automated dialing module 240 may also include a predictive dialing module 244. The predictive dialing module 244 is operable to determine the frequency of calls to be made. This determination may be based on the number of agents available to verify a contact phone number. For example, the predictive dialing module 244 may include logic that dictates that the dialer module 242 initiates a specific number of calls per minute per number of agents that can verify contact telephone numbers, agents that may be tasked with multiple tasks other than verifying contact telephone numbers. This logic may be based on historical performance (for example, availability of an agent over the last 30 minutes, at that time each day, or on that day of the month) that provides an indication of the optimal use of the dialer. In other words, the logic “predicts” when an agent will be available to verify a contact telephone number. In another embodiment, the dialing campaign may not be predictive. For example, the dialer may initiate a call only when an agent becomes available to confirm the contact telephone number or initiate a specific number of calls per agent (for example, four calls for each agent present), without basing that rate on a prediction of the availability of an agent.

Additionally, the automated dialing module 240 may include a virtual messaging module 246. The virtual messaging module 246 allows the automated dialing module 240 to provide virtual messages upon connecting with a party during a dialing campaign, that is, either when a person or machine answers a placed telephone call. For example, upon connecting to a person or machine, a virtual message may be sent that is heard over the telephone or recorded by an answering machine. An exemplary message might be, “We have important information for John Smith, with a credit card account ending with the number 1234. If we have reached the correct John Smith, please call us at 706-555-9876 and one or our representatives will help you.” Other message content could be used.

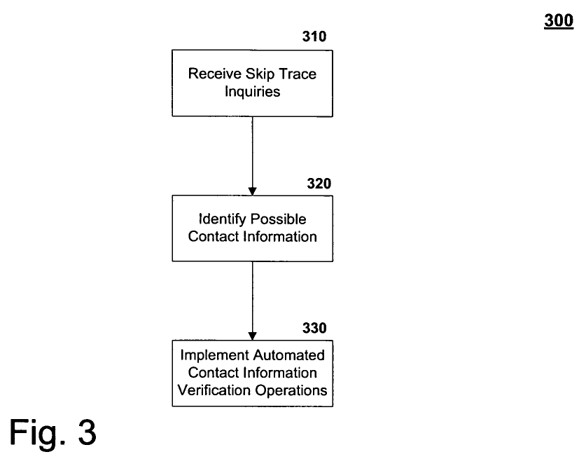

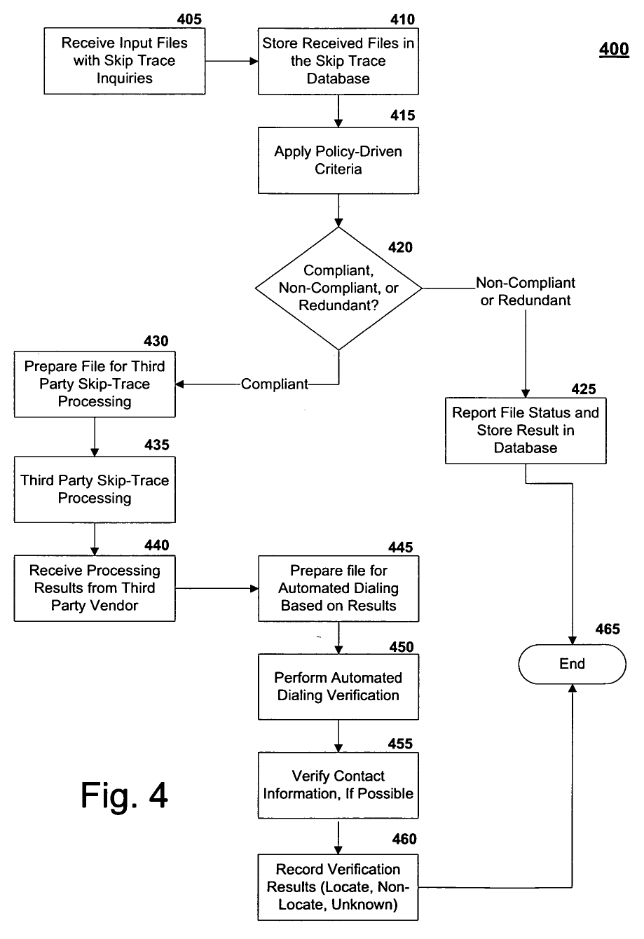

FIG. 3 depicts an overall process flow diagram 300 for providing an automated skip trace in accordance with an exemplary embodiment of the present invention. Referring to FIGS. 1, 2, and 3, a skip trace process can be divided into three general steps. FIG. 4, discussed below, provides additional details on this overall process. At step 310, a skip trace processor, such as skip trace database server 110 employing the data receipt module 210 and the policy module 220, receives skip trace inquiries. These inquiries may be maintained in a skip trace queue awaiting processing. The data receipt module 210 receives and processes each individual skip trace case and the policy module 220 determines if each case is compliant with established policies, that is, if the case should be processed for a skip trace.

At step 320, each skip trace inquiry that passes the policy module 220, or case, is processed to identify possible contact information, such as a telephone number, street address, or electronic mail address. This step may include using third-party databases that typically contain contact information, such as the “white pages,” credit bureaus, and government entities.

At step 330, an automated campaign is implemented to verify the contact information. This automated campaign would employ computer technology to automatically attempt to contact the subject of the skip trace through the possible contact information, such as automatically placing telephone calls or sending electronic mail messages. For example, an automatic dialer 180 employing the automated dialing module 240 may place calls to the possible phone numbers. In an exemplary embodiment, an automated campaign may include virtual messages sent by the automated dialing module 240 upon connecting with a party, such as a person or an answering machine.

FIG. 4 depicts a detailed process flow diagram 400 for providing an automated skip trace in accordance with an exemplary embodiment of the present invention. Referring to FIGS. 1, 2, and 4, at step 405, the skip trace database server 110 employing the data receipt module 210, receives files representing skip trace inquiries, or cases. These files may be received from the account processing platform 120, by way of electronic mail received at the electronic mail server 140, or as a formatted file uploaded to the file transfer server 160.

At step 410, the data receipt module 210 stores received files in a skip trace database resident on the skip trace database server 110. At step 415, the policy module 220 evaluates each stored input file for compliance with skip trace policies. These policies may include the magnitude of the balance on the account. For example, accounts with a small balance may not be processed because the return does not warrant the cost of the skip trace process. Another policy may be the length of time that an account has been delinquent. An account provider may designate that a skip trace should not be processed if the account is less than 30 days delinquent. In another example, a skip trace may not be processed if the account status shows the account as fraudulent, perhaps indicating that the account holder was fictitious. In another example of a policy, accounts associated with an individual in bankruptcy proceedings may not be processed. Of course, other policies may be used. Also, policies may be specific to an account provider. As such, one account provider may have one set of policies while another account provider may have a different set of policies.

At step 420, the policy module 220 determines if the skip trace inquiry is “compliant,” that is, it satisfies all policies for the specific account, “non-compliant,” that is, it does not satisfy one or more policies, or “redundant.” In finding that an account is “non-compliant,” the policy module 220 may not evaluate all policies but instead stop its determination after determining that one of the policies are not satisfied. A redundant account is one that is the subject of a different skip trace process. For non-compliant or redundant cases, the process 400 moves to step 425 and the policy module 220 reports the file status, which is stored in the skip trace database of the skip trace database server 110. The process 400 then moves to step 465 and ends.

For compliant cases, the process 400 moves to step 430, where the skip trace processing module 230 prepares the file for third-party skip trace processing. The file is then sent to a third party vendor, such as one with the third party skip trace database server 170. Alternatively, the skip trace database server 110 may access contact information data sources to search for contact information for the target of the skip trace. At step 435, the third party processes the skip trace case by attempting to locate contact information for the subject of the skip trace case.

At step 440, the skip trace processing module 230 receives the results from the third party vendor. Of course, this step may be replaced with the skip trace processing module 230 receiving raw contact data, in the alternative embodiment where the skip trace processing module 230 interrogates contact data sources directly. At step 445, the skip trace processing module 230 formats the received information and prepares a file for use in an automated contact campaign, such as by the automatic dialer 180.

At step 450, the automatic dialer 180, employing the automated dialing module 240, performs a dialing campaign, calling possible contact telephone numbers. In an alternative embodiment, this campaign may include sending electronic mail messages. The sequence and timing of placing the calls may be based on the automated dialing module 240 determining when an agent would be available to verify a contact telephone number.

At step 455, the automated dialing module 240 routes a call to an agent for verification. At this step, the automated dialing module 240 determines that the phone has been answered or is otherwise operational (for example, not a disconnected phone number or busy signal) and the call is transferred to an agent to verify that a person at that phone number is the account holder trying to be located. In an alternative embodiment, instead of connecting to a live agent, the automated dialing module 240 may send a virtual message upon connecting to a party, such as a person or answering machine.

In an alternative embodiment, the automated dialing module 240 may not transfer a call to an agent unless it determines that the automatic dialer 180 reached an actual person. The automated dialing module 240 may include logic that determines that, for an unusual name, reaching an operational phone number is sufficient for verifying the contact information of an individual, since a message can be left on an answering machine in some cases. As an example, if the subject of the skip trace case is named “Victor Laszlo,” then the logic of the automated dialing module 240 may determine that any connection to an operation phone number (except, likely, a busy signal) should be routed to an agent, who could leave a message for the individual in an answering machine answers the phone. But, if the subject of the skip trace case was named “John Smith,” a connection with an answering machine may be insufficient for verification, so the automated dialing module 240 may verify that an actual person answers the phone before routing the call to an agent. If virtual messaging is being used, likely a virtual message would be sent upon connecting with any party (such as a person or answering machine), regardless of the party's name.

The results of the dialing campaign are stored in the database of the skip trace database server 110. The result of the verification is recorded by the agent with a specified disposition code. The disposition code then translates to a decision point for the automated dialing module 240 by which the account is flagged, for example as “Locate,” “Non-Locate,” or “Unknown.” For cases flagged as “Locate,” a potential contact number has been verified and the case is not resubmitted for further dialing nor continued processing within the skip trace database server 110. For cases flagged “Non-Locate,” the potential contact numbers are determined to not be the correct account holder. The automated dialing module 240 automatically applies this disposition to those outbound calls resulting in a Not-In-Service (NIS) notification or simple disconnects. For electronic mail, messages that were returned as undeliverable would be given this designation. For cases flagged “Unknown” neither a Locate nor Non-Locate designation can be determined, perhaps because of no answer or an answering machine. For electronic mail, if no reply to an automated message was received, the case would be designated as “Unknown.”

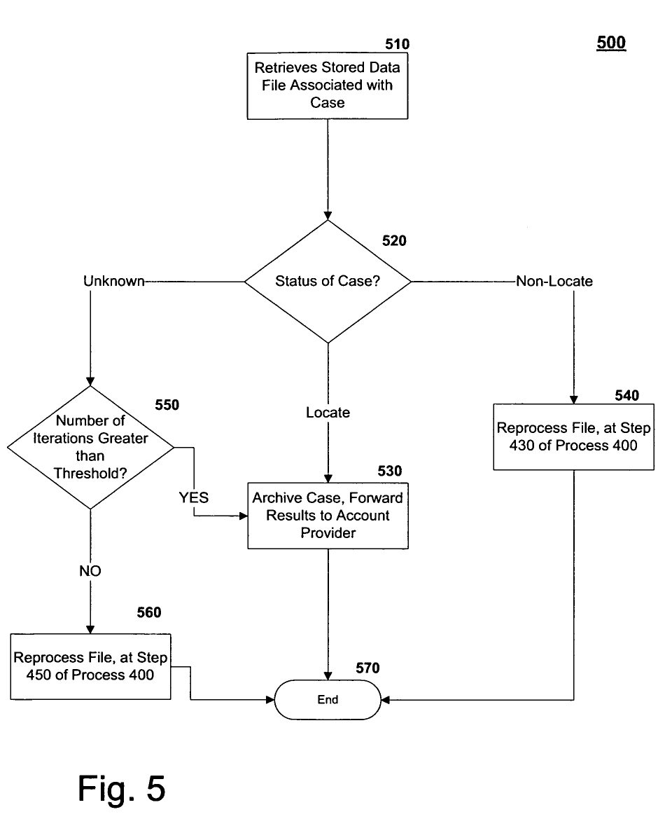

At step 460, the automated dialing module 240 exports a results file to the skip trace database server 110 to be retrieved and used for reporting purposes and for further processing. Further processing is described below, in connection with FIG. 5. Process 400 may be run as a continuous process or as a batch process.

FIG. 5 depicts a detailed process flow diagram 500 for further processing an automated skip trace case in accordance with an exemplary embodiment of the present invention. Referring to FIGS. 1, 2, 4,and 5, at step 510, the skip trace processing module 230 retrieves the stored data file associated with the case. At step 520, the skip trace processing module 230 determines the status of the case (Locate, Non-Locate, or Unknown). If the result at step 520 is that the status is Locate, the case moves to step 530, where it is archived and the results are forwarded to the account provider. If the status is Non-Locate, the process 500 moves to step 540 and the file is reprocessed, beginning at step 430, as described above in connection with FIG. 4. The skip trace processing module 230 may include logic that terminates this repeat processing based on the number of times that this case has been processed. Also, the file preparation step of 430 may include preparing the file for alternative sources of contact information. That is, the process may employ a tiered approach to the types of sources of contact information that are reviewed.

If the status is Unknown, the process 500 moves to step 550 and the skip trace processing module 230 determines the number of attempts that have been made for this case. If the number of attempts exceeds a threshold of this case, the process moves to step 530, where it is archived and the results are forwarded to the account provider. Of course, different account providers may have different thresholds. If the result at step 550 is “NO,” the process 500 moves to step 560 and the file is reprocessed, beginning at step 450, as described above in connection with FIG. 4.

One of ordinary skill in the art would appreciate that the present invention supports systems and methods that automate a skip trace process for identifying contact information for account holders of financial accounts or individuals with other financial obligations that cannot otherwise be reached. The systems and methods may include the ability to submit skip trace inquiries through a variety of platforms, including electronic mail, formatted file, or directly from a financial account processing system. The systems and methods interact with third party data sources, data aggregators, or data processors to identify potential contact information for the individual. The systems and methods incorporate automated contact campaigns to verify any possible contact information retrieved.

What is claimed:

1. A system for automated skip tracing comprising:
a data receipt module, operable to receive a skip trace inquiry comprising a financial account;
a policy module, operable to apply one or more policies to the skip trace inquiry received by the data receipt module to identify one or more skip trace inquiries for processing;
a skip trace processing module; operable to process the skip trace inquiries identified by the policy module by requesting and receiving contact information associated with the processed skip trace inquiries; and
an automated dialing module; operable to automatically initiate communications using the received contact information.

2. The system of claim 1 wherein the contact information comprises telephone numbers.

3. The system of claim 2 further comprising a predictive dialing module operable to employ predictive dialing to initiate a telephone call.

4. The system of claim 3 further comprising a virtual messaging module operable to send a virtual message upon the telephone call connecting with a party.

5. The system of claim 1 wherein the skip trace inquiries comprise electronic mail communications.

6. The system of claim 1 wherein the skip trace inquiries comprise financial account information from a financial account processing platform.

7. A system for automated skip tracing comprising:
one or more servers, logically connected to a network and operable to receive a skip trace inquiry comprising a financial account, to apply one or more policies to the skip trace inquiry received by the server to identify one or more financial accounts for skip trace processing, and to process the skip trace inquiries identified by the policy module by requesting and receiving contact information associated with the processed skip trace inquiries; and
an automated dialer; operable to automatically initiate communications using the received contact information.

8. The system of claim 7 wherein the contact information comprises telephone numbers.

9. The system of claim 8 wherein the automated dialer is further operable to employ predictive dialing to initiate a telephone call.

10. The system of claim 7 further comprising a virtual messaging module operable to send a virtual message upon the telephone call connecting with a party.

11. The system of claim 7 wherein the skip trace inquiries comprise electronic mail communications.

12. The system of claim 7 wherein the skip trace inquiries comprise financial account information from a financial account processing platform.

13. The system of claim 7 wherein at least one of the servers is connected over a wide area network to one or more data sources comprising contact information.

14. A method for automating skip tracing, comprising the steps of:
a) receiving a skip trace inquiry comprising a financial account;
b) applying one or more policies to determine if the skip trace inquiry should be processed;
c) processing the skip trace inquiry to identify contact information for an individual associated with the skip trace inquiry; and
d) automatically initiating contact with the individual associated with the skip trace inquiry using the contact information.

15. The process of claim 14 wherein step c) further comprises the steps of:
preparing the skip trace inquiry for processing by a third party; and
receiving the results of the third party processing comprising contact information.

16. The method of claim 14 wherein steps c) and d) are repeated the individual associated with the skip trace is not located.

17. The method of claim 14 wherein at least one policy is specific to an account provider of the financial account.

18. The method of claim 14 wherein the step of automatically initiating contact comprises a telephone call, the method further comprising the step of providing a virtual message upon the telephone call connecting with a party.
